(19) United States
(12) Patent Application Publication
(10) Pub. No.: US 2012/0185876 A1
(43) Pub. Date: Jul. 19, 2012

(54) CONTROL DEVICE, CONTROL METHOD, AND COMPUTER READABLE MEDIUM

(75) Inventors: Takenori Abe, Yokkaichi-shi (JP); Takeshi Karo, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/498,438

(22) PCT Filed: Oct. 7, 2010
(86) PCT No.: PCT/JP2010/067661

§ 371 Date: Mar. 27, 2012

(30) Foreign Application Priority Data
Oct. 8, 2009 (JP) 2009-234466

(51) Int. Cl. G06F 9/54; G06F 3/00; G06F 9/44

(52) U.S. Cl. 719/313

(57) ABSTRACT

An intermediate processing layer including AP input and output processing sections and conformed to the input and output of the application side and PF input and output processing sections and conformed to the input and output of the platform side is provided between an application layer and a platform layer, and the processing sections are conformed based on an externally set definition table in which input and output of each application program and platform program are defined.

(US) This application is the national phase under 35 U.S.C.§371 of PCT International Application No. PCT/JP2010/067661 which has an International filing date of Oct. 7, 2010 and designated the United States of America.

### BACKGROUND OF THE INVENTION

1. Field of the Invention

The present invention relates to a control device in which an application program and a platform program directly related to the control of hardware resources are executed. In particular, the present invention relates to a control device, a control method and a computer program in which it is unnecessary to make program alteration every time the application program and the platform program or either one of them is changed in specifications, so that reusability and development efficiency can be improved.

2. Description of Related Art

In recent years, in various fields, a system has been used in which a plurality of control devices performing various controls which devices are provided with a communication function are connected and the control devices are each assigned a function, exchange data with each other and are caused to perform various processings in cooperation with each other. For example, in the field of the in-vehicle LAN (local area network) provided in vehicles, ECUs (electronic control units) have a communication function, and the ECUs are each caused to perform a specific processing and exchange data with each other, thereby implementing various functions as a system (see, for example, Patent Document 1).

The ECUs operate while performing input and output of a control signal and a state signal with hardware resources. For the ECUs, a driver program is used that mediates between mechanical processing of signal input and output and software processing of implementing the specific function of each ECU. When a multiplicity of ECUs are used, it is inefficient to individually develop the driver program in accordance with the hardware resources provided in the ECUs or connected to the ECUs.

Therefore, as disclosed in Patent Document 2, a program construction is adopted in which a processing or the like independent of the difference in hardware resources is generalized and the program related to the hardware resources is commonalized as the platform program so that conformance to various application programs is achieved.

### PRIOR ART REFERENCE

### Patent Document

[Patent Document 1] Japanese Patent Application Laid-Open No. 2007-329578

[Patent Document 2] Japanese Patent Application Laid-Open No. 2004-192541

### SUMMARY OF THE INVENTION

Since the difference of the interface can be accommodated by providing a connection processing section between the application program and the platform program as in the invention disclosed in Patent Document 2, the application program can be used also when a hardware resource of different specifications is used, so that development efficiency improves.

However, a case is considered where efficiency improvement is insufficient even though the structure with the connection processing section is adopted. For example, it is assumed that when the hardware resource is changed or when the specifications thereof are changed, the interface of the platform program is changed accordingly. In this case, in order that it is unnecessary to alter the application program as well, it is necessary to alter the connection processing section so as to conform to the interface of the new platform program while conforming to the interface of the application program. If the application program is changed next, it is necessary to conform the connection processing section to the interface of the new application program while conforming it to the interface of the platform program. That is, it is necessary to conform the connection processing section in accordance with the combination of the application program and the platform program.

There is also a case where a plurality of different application programs are executed in one ECU. In this case, when a request to read the same data is made by the application programs, even though the connection processing section is provided, in the structure in which the connection processing section is independently conformed to the different application programs, the same data is read and transmitted a plurality of times and this makes the processing redundant. Thus, the overall reduction in the processing load on the ECU is insufficient.

Further, even for a combination of an application program and a platform program that implement the same function, depending on the destination of the vehicle mounted with the ECU, there sometimes exits data that should not be inputted, data that should not be outputted or the like. In this case, in the structure in which the input and output format is changed according to each of the application programs and platform programs, development is necessary for each destination and this reduces development efficiency.

The present invention is made in view of such circumstances, and an object thereof is to provide a control device, a control method and a computer readable medium in which in the intermediate layer between the application program and the platform program, the connection processing (intermediate processing) section is divided into two layers on the side of the interface of the application program and on the side of the interface of the platform program and the processing in each of the two layers is commonalized, whereby development efficiency can be improved.

According to the present invention, an intermediate processing execution section (intermediate processing program) that conforms the input and output between the application program and the platform program depending on the hardware resource to be controlled, to the application program and to the platform program is divided into two of the side where the input and output by the application program is processed and the side where the input and output by the platform program is processed. Further, in each of the application program side processing and the platform program side processing, conversion is performed based on a table that can be externally set as appropriate. By doing this, even when the application program is changed, the hardware resource is changed or the specifications are changed, input and output are appropriately performed only by changing the table without the processing by the intermediate processing execution section being changed.

According to the present invention, the table includes definition information on the number of pieces, type or format of the input and output data of the application program. In the intermediate processing execution section, by implementing a structure in which data is taken out or inputted in the number of pieces, type or format based on the definition information, conforming input and output can be performed by associating the definition information referred to with the application program.

According to the present invention, the table includes definition information on the number of pieces, type or format of the input and output data of the platform program. In the intermediate processing execution section, by implementing a structure in which data is inputted and outputted in the number of pieces, type or format based on the definition information, conforming input and output can be performed by associating the definition information referred to with the specifications of the platform program.

According to the present invention, the data inputted and outputted by the application program is classified according to the data kind, and input and output are performed for each classification. Pieces of data classified into the same group are highly likely to be used together by the application program. The number of times of input and output can be made fewer than when pieces of data classified into the same group are inputted and outputted one by one, so that the overall scale of the program can be reduced, the overall processing load on the control device can be reduced and the processing speed can be improved.

According to the present invention, the input and output of data that should be made invalid depending on the specifications of the control device or the destination can be invalidated in the intermediate processing execution section. This makes it unnecessary to change the input and output specifications of the application program, so that development efficiency can be improved.

In the case of the present invention, even when the application program is changed, the hardware resource is changed or the specifications are changed, this can be handled by changing the table that the intermediate processing execution section (intermediate processing program) refers to. Consequently, fewer changes in the structure of the intermediate processing execution section are necessitated, so that general versatility improves and development efficiency improves.

Further, in the case of the present invention, the structure in the intermediate processing execution section (intermediate processing program) is also generalized, and change of the application program, change of the hardware resource or change of the specifications can be handled only by updating the definition information table, so that reusability improves.

The above and further objects and features of the invention will more fully be apparent from the following detailed description with accompanying drawings.

### BRIEF DESCRIPTION OF THE DRAWINGS

FIG. 1 is a block diagram showing the structure of an ECU in the present embodiment;

FIG. 2 is an explanatory view conceptually showing functions implemented by a CPU of the ECU in the present embodiment;

FIG. 3 is an explanatory view showing an example of the contents of a definition table referred to by the CPU of the ECU in the present embodiment as AP input and output processing sections;

FIG. 4 is an explanatory view showing an example of the contents of the definition table referred to by the CPU of the ECU in the present embodiment as PF input and output processing sections;

FIG. 5 is an explanatory view conceptually showing data inputted and outputted in group units;

FIG. 6 is an explanatory view showing an example of the contents of the definition table storing information invalidated for each destination; and

FIG. 7 is an explanatory view conceptually showing a structure in which the input and output data creation processing in each application program is substitutively executed in the intermediate processing layer.

### EXPLANATION OF ITEM NUMBERS

1 ECU (control device)
11 CPU (processor)
12 ROM (memory)
14 storage section
16 application program
106 application layer (first program execution section)
17 platform program
107 platform layer (second program execution section)
171 PF I/F
18 intermediate program
108 intermediate processing layer (intermediate processing section)
181 AP I/F
182 AP output processing section (first processing section)
183 AP input processing section (first processing section)
184 PF output processing section (second processing section)
185 PF input processing section (second processing section)

### DESCRIPTION OF THE PREFERRED EMBODIMENTS

Hereinafter, the present invention will be specifically described with reference to the drawings illustrating embodiments of the present invention.

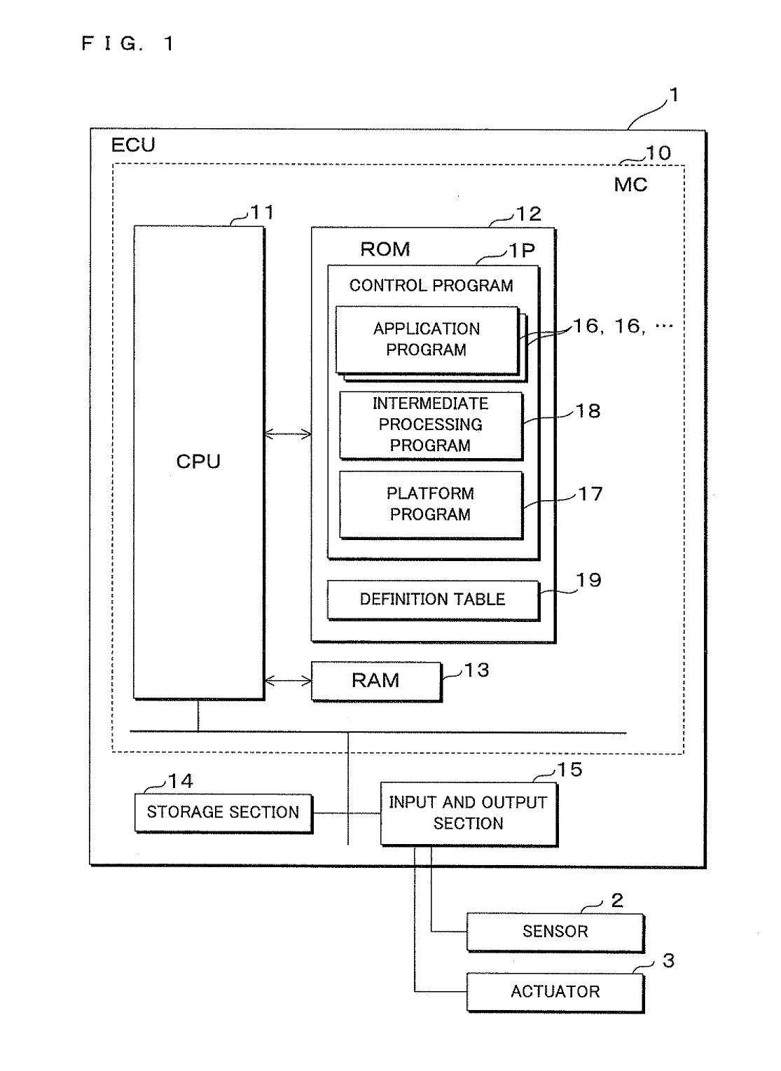

FIG. 1 is a block diagram showing the structure of an ECU in the present embodiment. The ECU 1 is mounted on a vehicle, and controls the driving of the vehicle or the operations of mechanisms such as doors, mirrors or the like. To the ECU 1, a sensor 2 and an actuator 3 are connected. The ECU 1 has a particular function such as operating the actuator 3 based on information acquired from the sensor 2 or operating the actuator 3 based on information acquired through the processing by another ECU that is not shown. While both the sensor 2 and the actuator 3 are connected to the ECU 1, it may be only one of them or none of them that is connected.

The ECU 1 is provided with: a microcomputer 10 (hereinafter, referred to as MC 10) including a CPU (central processing unit, CPU core) 11 that controls the operations of the components, a ROM (read only memory) 12 as which a nonvolatile memory is used and a RAM 13 as which a memory capable of quick access is used; a storage section 14 as which a nonvolatile memory is used; and an input and output section 15 as the interface with the sensor 2 and the actuator 3.

As the storage section 14, a memory such as a flash memory or an EEPROM (electrically erasable and programmable ROM) is used. The storage section 14 is structured so as to have a comparatively larger storage capacity than the ROM 12 and the like. The storage 14 stores information acquired through the processing performed by the MC 10 executing application programs 16 described later, for example, system information such as information on the condition of the ECU 1 or information on the condition of the vehicle mounted with the ECU 1. The storage section 14 also stores data acquired by the MC 10 from the sensor 2, data received from other ECUs, and the like.

The input and output section 15 is the interface with the sensor 2 and the actuator 3 as mentioned above. When the sensor 2 is connected, the input and output section 15 takes out a signal representative of a measurement value or the like outputted from the sensor 2, and outputs it to the MC 10. When the actuator 3 is connected, the input and output section 15 outputs, to the actuator 3, a control signal of the actuator 3 outputted from the MC 10. The input and output section 15 may have a D/A conversion and A/D conversion functions.

The CPU 11 of the MC 10 reads a control program 1P stored in the ROM 12 to the CPU 11 or to the RAM 13, and executes it to thereby control the components, thus implementing a particular function.

As the ROM 12, a memory such as a mask ROM, a flash memory, a PROM (programmable ROM), an EPROM (erasable and programmable ROM) or an EEPROM (electrically EPROM) is used. The ROM 12 may store control data used for control as well as stores the control program 1P as mentioned above.

As the RAM 13, a memory such as a DRAM (dynamic random access memory) or an SRAM (static random access memory) is used. The RAM 13 temporarily stores various pieces of information generated through the processing by the CPU 11.

The control program 1P stored in the ROM 12 includes: the application programs 16 for causing the MC 10 to execute the processing particular to the ECU 1; a platform program 17 including various programs for implementing hardware resource control; and an intermediate processing program 18 that mediates exchanges between the application programs 16 and the platform program 17.

The application programs 16 include various programs for implementing the function particular to the ECU 1 such as a program for implementing the processing for switching between on and off of door lock, on and off of a vehicle interior lamp, on and off of the headlamps or the like, or the processing of making a diagnosis of whether the own operation is normal or abnormal.

The platform program 17 includes programs for implementing processing on the hardware resources in response to a processing request to the hardware resources from the MC 10 based on the application programs 16 such as control signal input and output to and from the sensor 2 or the actuator 3 through the input and output section 15, data writing to the storage section 14 and data reading from the storage section 14. Specifically, the platform program 17 includes: a device driver that implements the logical data access in response to the processing request from the CPU 11 executing the application programs 16; and a BIOS (basic input/output system) that implements physical data access based on the mounting of the hardware resources.

The intermediate processing program 18 includes a program for implementing an interpreter function such as converting a processing request from the application programs 16 so as to conform to the platform program 17 and transmitting it to the platform program 17. Specifically, the intermediate processing program 18 implements an output-related intermediate processing function of accepting a driving request from the CPU 11 based on the application programs 16 such as a driving request to the actuator 3 or a data writing request to the storage section 14 in the number of pieces, type or format of data conforming to the application programs 16, converting it to the number of pieces, type or format of data accepted by the platform program 17, and transmitting it to the platform program 17. The intermediate processing program 18 also implements an input-related intermediate processing function of accepting data inputted from the platform program 17, performing conversion or the like on the data so that it can be interpreted by the application programs 16, and transmitting the data to the application programs 16.

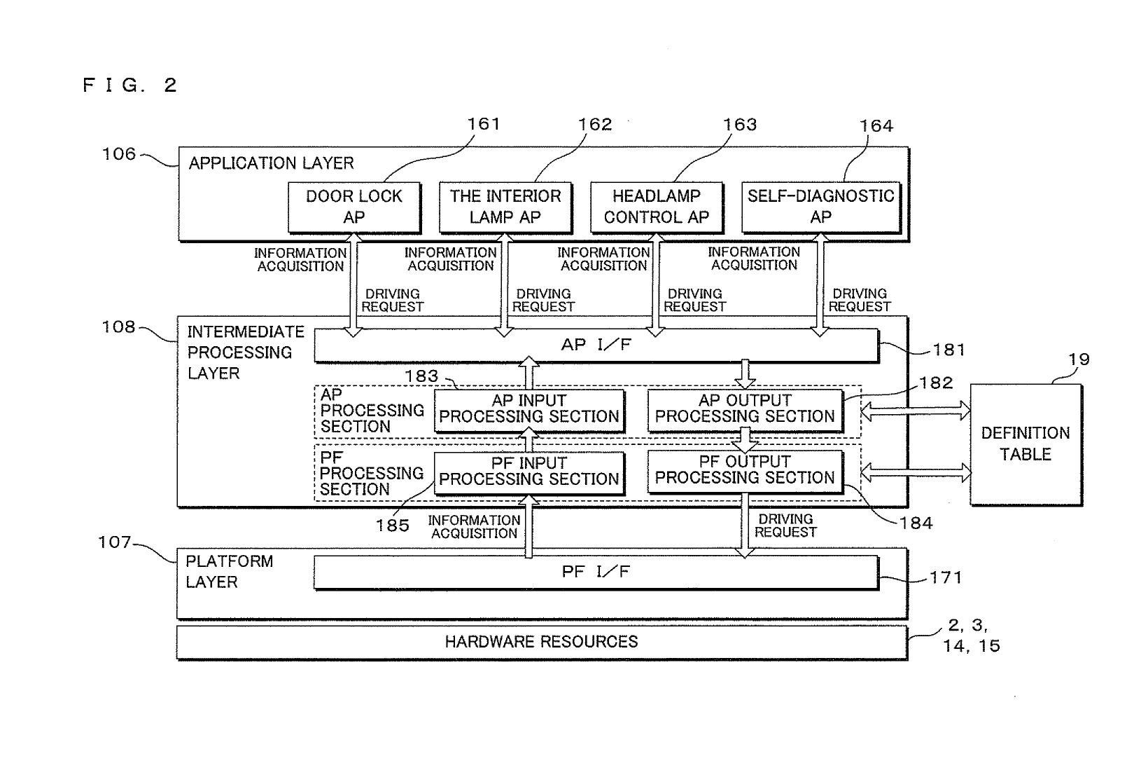

FIG. 2 is an explanatory view conceptually showing functions implemented by the CPU 11 of the ECU 1 in the present embodiment. In FIG. 2, AP stands for application, and PF stands for platform. The CPU 11 reads the control program 1P stored in the ROM 12, to the CPU 11 or to the RAM 13 for execution. The control program 1P includes the application programs 16, the platform program 17 and the intermediate processing program 18 as mentioned above. The CPU 11 operates based on the programs included in the control program 1P in a software structure divided into three hierarchies of an application layer 106, an intermediate processing layer 108 and a platform layer 107.

In the uppermost application layer 106, the CPU 11 functions as various applications (in the present embodiment, a door lock AP 161, an interior lamp AP 162, a headlamp control AP 163, and a self-diagnostic AP 164) based on the application programs 16.

In the lowermost platform layer 107, based on the platform program 17, the CPU 11 performs the processing to control hardware resources 2, 3, 14, 15, in the physical layer through a PF I/F 171 which is call interfaces with the hardware resources 2, 3, 4, 15,

In the intermediate processing layer 108, the CPU 11 accepts driving requests from the applications in the application layer 106 at a commonalized AP I/F 181 based on the intermediate processing program 18. The applications in the application layer 106 commonly call the AP I/F 181 to thereby acquire information.

Moreover, in the intermediate processing layer 108, the CPU 11 functions as an AP output processing section 182 that converts the driving requests from the applications as data conforming to the applications based on the intermediate processing program 18. Further, the CPU 11 functions as an AP input processing section 183 that performs conversion, in response to a call for information acquisition from the applications, so that data conforming to the applications is referred to.

Specifically, for example, for a driving request from the door lock AP 161, based on the definition information in a definition table 19 for the door lock AP 161, the AP output processing section 182 converts it so that it is a driving request related to door lock. Describing in detail, when a driving request related to the N-th object is received from the door lock AP 161 and a driving request related to the same Nth object is received from the interior lamp AP 162, the AP output processing section 182 converts the driving requests in accordance with the applications such as converting the driving request from the door lock AP 161, for example, so that it is a request related to the door lock of the front passenger's door and converting the driving request from the interior lamp AP 162, for example, so that it is a request related to a ceiling light.

In like manner, for example, when information acquisition related to the M-th object is received from the door lock AP 161 and information acquisition related to the same M-th object is received from the interior lamp AP 162, the AP input processing section 183 converts the information acquisition from the door lock AP 161 so that it is the acquisition of information on the door lock condition of the driver's door, and converts the information acquisition from the interior lamp AP 162, for example, so that it is the acquisition of information on the lighting condition of a lamp on a lower part of a door. In this manner, the functions as the AP processing sections for processing the inputs and outputs with the applications as appropriate according to the specifications are implemented.

Further, in the intermediate processing layer 108, the CPU 11 functions as a PF output processing section 184 that converts the driving requests from the applications to data conforming to the platform based on the intermediate processing program 18. Further, the CPU 11 functions as a PF input processing section 185 that converts the information acquisition to the applications to information acquisition in the format conforming to the platform.

As shown in FIG. 2, the intermediate processing layer 108 is divided into two layers of the AP processing sections (the AP input and output processing sections 182 and 183) that perform conversion to the input and output conforming to the applications and the PF processing sections (the PF input and output processing sections 184 and 185) that perform conversion to the input and output conforming to the PF I/F 171 of the platform layer 107, whereby conformance to various applications and various hardware resources can be achieved.

Next, the processing by the AP input and output processing sections 182 and 183 will be concretely described. As described above, the AP output processing section 182 and the AP input processing section 183 appropriately convert the data to be processed, according to with which application the input and output are exchanged. Specifically, the AP output processing section 182 and the AP input processing section 183 perform conversion with reference to a table in the definition table 19 for the application which is the requester or the information acquirer.

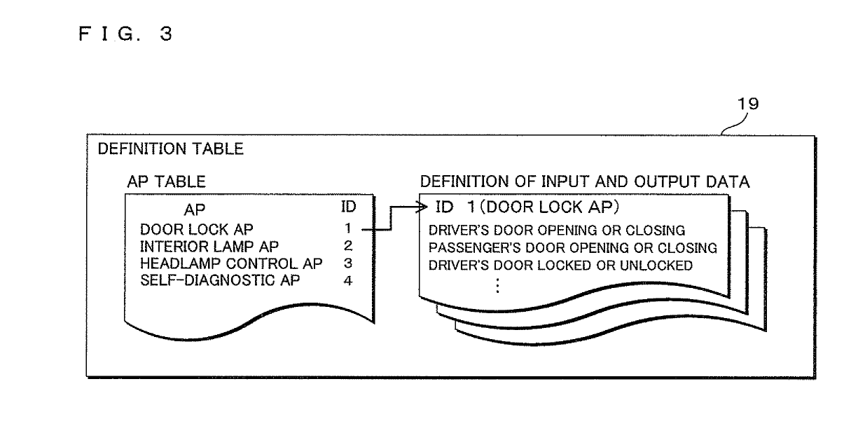

FIG. 3 is an explanatory view showing an example of the contents of the definition table 19 referred to by the CPU 11 of the ECU 1 in the present embodiment as the AP input and output processing sections 182 and 183. As shown in FIG. 3, the definition table 19 includes, as an application table, a list of the identification information (ID) of the applications that operate in the application layer 106, that is, the door lock AP 161, the interior lamp AP 162, the headlamp control AP 163 and the self-diagnostic AP 164. The application table is associated with the definition of the input and output data by the ID for each application. As shown in FIG. 3, the door lock AP 161 is assigned with an ID number “1”. The input and output data of ID “1” is defined by two values such as the opening and closing of the driver's door, the opening and closing of the front passenger's door and the locking and unlocking of the driver's door.

For example, a case is considered where there is a data output of one byte as a driving request from the door lock AP 161. At this time, by the function as the AP input processing section 183, the CPU 11 recognizes the first bit of the outputted data as the opening or closing of the driver's door, the second bit thereof as the opening or closing of the front passenger's door and the third bit thereof as the locking or unlocking of the driver's door based on the definition table 19 as shown in FIG. 3. When the third bit represents locking, the CPU 11 notifies the function as the PF output processing section 184 that a driving request to lock the driver's door is made.

It is necessary for the AP I/F 181 simply to copy the data outputted from the applications and supply it to the AP output processing section 182. This enables the AP I/F 181 to have a structure independent of the applications. In this way, the input and output depending on the application program can be conformed to the calls from the applications while being generalized by the AP I/F 181 by the functions as the AP input and output processing sections 182 and 183 in the intermediate processing layer 108. Further, when a new application program is added or when the specifications of an existing application program are changed, by updating, rewriting or changing the definition table 19, it is unnecessary to update the programs implementing the AP input and output processing sections 182 and 183 and the AP I/F 181, and this necessitates fewer structure changes, so that general versatility, that is, reusability improves and development efficiency improves.

Next, the processing by the PF input and output processing sections 184 and 185 will be described. As described above, when the PF I/F 171 is called to perform driving request or information acquisition, the PF output processing section 184 and the PF input processing section 185 convert data as appropriate so as to conform to the PF I/F 171. Specifically, like the AP input and output processing sections 182 and 183, with reference to a table in the definition table 19 for the hardware resource which is the driving requester or the information acquirer, the PF output processing section 184 and the PF input processing section 185 set the number of pieces, type or format of data in accordance with each, and calls the PF I/F 171.

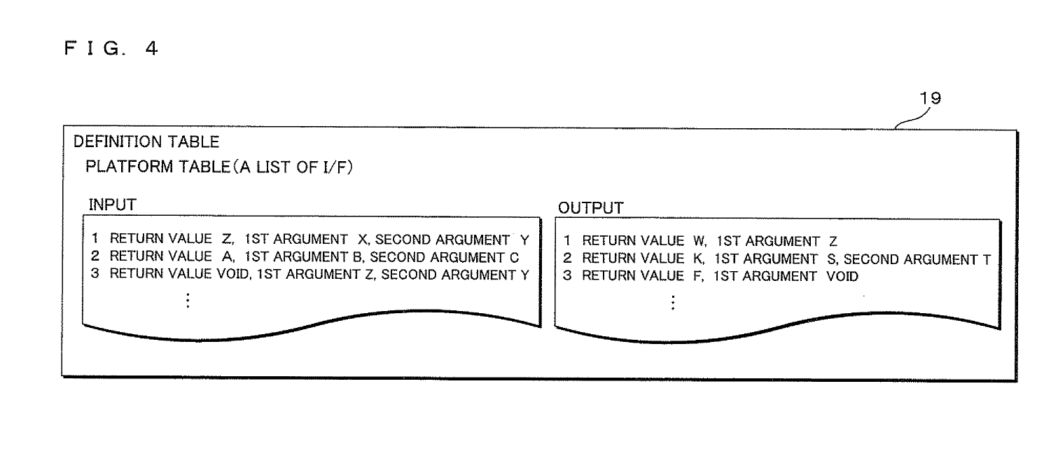

FIG. 4 is an explanatory view showing an example of the contents of the definition table 19 referred to by the CPU 11 of the ECU 1 in the present embodiment as the PF input processing section 184 and PF output processing section 185. As shown in FIG. 4, the definition table 19 includes a platform table in which a list of I/Fs (call functions) conforming to the hardware resources 2, 3, 14, 15, . . . , respectively is defined for each of input and output.

For example, when a driving request for locking the driver's door is received from the door lock AP 161 through the AP output processing section 182, the PF output processing section 184 extracts the I/F for locking the driver's door from the platform table. When it is assumed that the I/F for locking the driver's door is, for example, the “third” output I/F having no argument and returning success/unsuccess as the return value, the PF output processing section 184 calls the PF I/F 171 by the I/F's calling method.

For example, when the acquisition of information on the condition of the lamp on the lower part of the driver's door is received from the interior lamp AP 162 through the AP input processing section 183, the PF input processing section 185 recognizes calling of an I/F acquiring the conditions of the lamps on the lower parts of not only the driver's door but also the other doors, for example, the “first” input I/F. It is assumed that X of the first argument indicates transmitting a pointer corresponding to the information on the condition of the driver's door lamp and Y of the second argument represents transmitting a pointer corresponding to the information on the condition of the front passenger's door lamp. At this time, the PF input processing section 185 also defines the information on the condition of the front passenger's door lamp which is not the object of the information acquisition and calls the PF I/F 171, and transmits only the information on the condition of the driver's door lamp to the AP input processing section 183.

By doing this, calling to the platforms can be conformed to the hardware resources without the need for the applications to be conscious of the IF that differs according to the platform (hardware resource). In addition, by updating, rewriting or changing the platform table, it is unnecessary to update the program implementing the PF input and output processing sections 184 and 185, and this necessitates fewer structure changes, so that general versatility, that is, reusability improves and development efficiency improves.

Further, for the information acquisition and the driving request between the applications (the door lock AP 161, the interior lamp AP 162, the headlamp control AP 163, the self-diagnostic AP 164) and the AP I/F 181, a structure is desirable in which exchange, is performed all at once. Therefore, it is desirable that pieces of data exchanged at once be grouped so that data input and output is performed in group units.

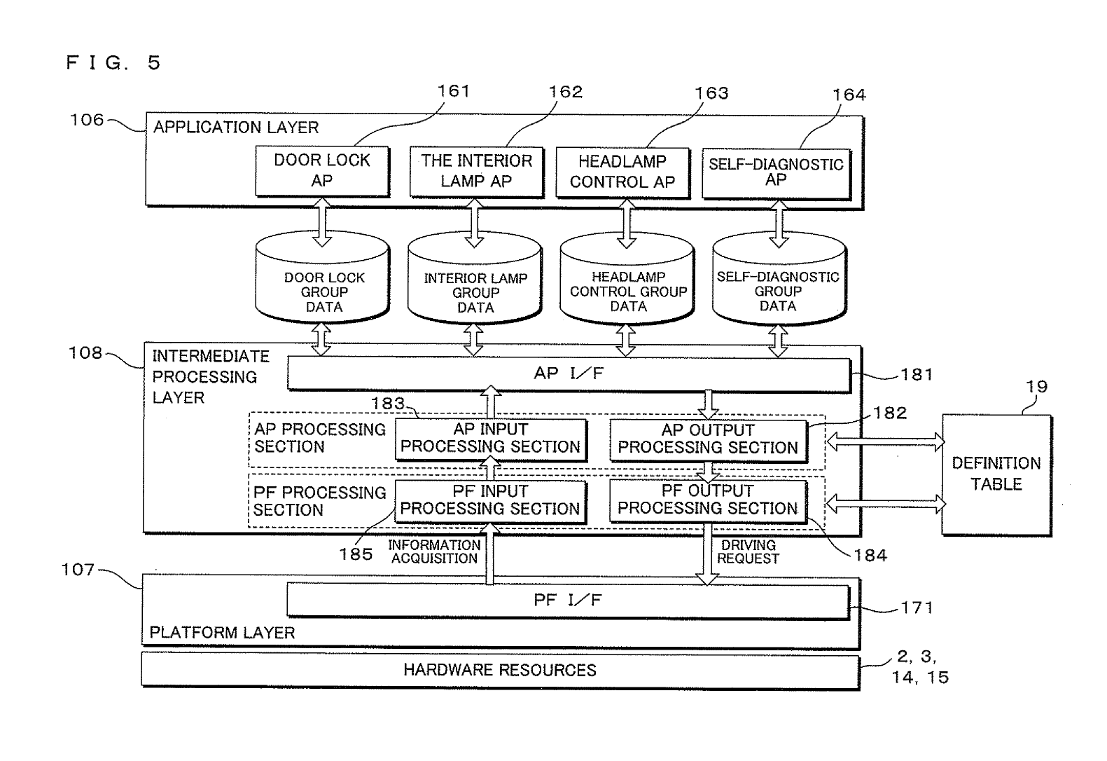

FIG. 5 is an explanatory view conceptually showing data inputted and outputted in group units. As shown in FIG. 5, the AP I/F 181 implements the acceptance of driving request or information acquisition from the applications by data input and output in group units. Specifically, for example, it is assumed that the door lock AP 161 successively requests the acquisition of pieces of information on the condition of the opening and closing of the driver's door, the condition of the opening and closing of the front passenger's door, the condition of the locking and unlocking of the driver's door, the condition of the locking and unlocking of the front passenger's door and the condition of the ignition key. At this time, these pieces of information are previously grouped as door lock group data. Then, from the door lock AP 161, the pieces of information are acquired not one by one but all at once, and the AP input processing section 183 expresses each piece of the door lock group data (the condition of the opening and closing of the driver's door, the condition of the opening and closing of the front passenger's door, the condition of the locking and unlocking of the driver's door, the condition of the locking and unlocking of the front passenger's door and the position of the ignition key) by one bit, and collectively returns them to the door lock AP 161 in a unit of one byte.

Moreover, when a database of all the input and output data is made and information acquisition of any of the data is received from the application layer 106 in the intermediate processing layer 108, it may be performed to call information acquisition from the PF I/F 171 in the platform layer 107 for each group and update the database. Moreover, the following may be performed: Pieces of data for which information acquisition can be performed by the same I/F with reference to the platform table are acquired all at once and the database is updated, and the AP I/F 181 returns the pieces of data in group units from the database in response to the information acquisition from the applications.

By doing this, the number of times of input and output can be reduced, so that the overall scale of the program can be reduced, the overall processing load on the control device can be reduced and the processing speed can be improved.

In the present embodiment, the ECU 1 is a control device mounted on a vehicle and controlling the driving of the vehicle or the operations of mechanisms such as doors, mirrors or the like. For the vehicle, even for the same type of vehicle using the same part such as an engine, there is a function or the like that must not be operated depending on the destination, and there are information that is not used and information that must be used. Moreover, even for the control device for the same object of control, the specifications partly differ according to the type or the grade, and there is a function or the like that should not be operated.

Accordingly, further, in the present embodiment, the information to be made invalid is invalidated by the AP input processing section 182 and the AP output processing section 183 or the PF input processing section 184 and the PF output processing section 185 in the intermediate processing layer 108. That is, in the intermediate processing layer 108, when information acquisition is received from any of the applications, even if the information concerned is acquired from the platform layer 107, it is returned to the application after replaced with a preset value (for example, zero).

Then, for each destination, which information should be invalidated is defined in the definition table 19. For example, the contents of the definition table 19 may be changed for each destination, or to the definition table 19, a condition may be added such as causing the application to acquire information “for a given destination”, “only when an effective signal is received through communication” or “only when the data stored in the storage section 14 is a specific value” for each piece of information.

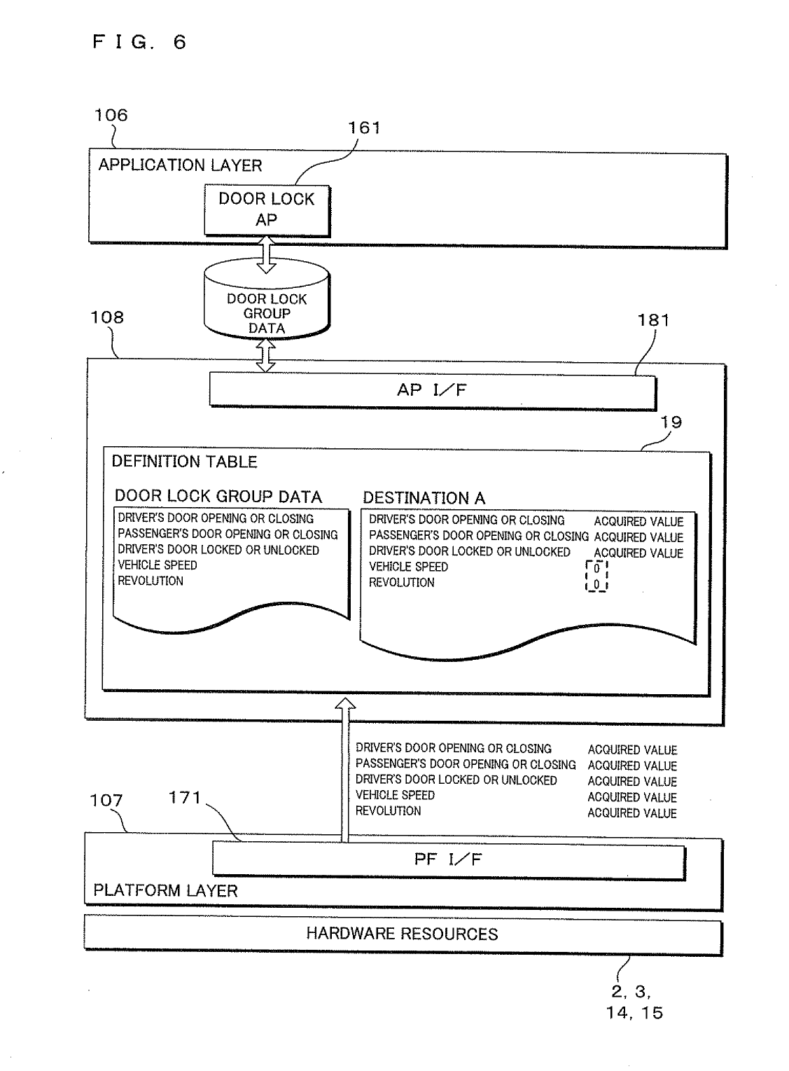

FIG. 6 is an explanatory view showing an example of the contents of the definition table 19 storing information invalidated for each destination. As shown in FIG. 6, the definitions of the input and output data are grouped for each destination.

FIG. 6 shows an example of the door lock Group data. The door lock Group data includes the vehicle speed and the number of revolutions as well as the conditions of the opening and closing of the driver's door, the opening and closing of the front passenger's door and the locking and unlocking of the driver's door. In the example shown in FIG. 6, the following is stored in the definition table 19: As shown by the broken line, in the case of a destination A, for the vehicle speed and the number of revolutions, zero is set as the input value and the use of the information should be invalidated. When the AP I/F 181 receives information acquisition from the door lock AP 161, the AP input processing section 183 or the PF input processing section 185 reads, for example, invalidation information for the destination that is set in the storage section 14 or in the ROM 12 from the definition table 19. Then, of the pieces of information of the opening and closing of the driver's door, the opening and closing of the front passenger's door, the locking and unlocking of the driver's door, the vehicle speed and the number of revolutions acquired through the PF I/F 171, the vehicle speed and the number of revolutions defined as being to be invalidated in the definition table 19 are set not to the values obtained through the PF I/F 171 but to “zero” by the AP input processing section 183 or the PF input processing section 185, and are returned to the door lock AP 161 by the AP I/F 181.

The AP input processing section 183 or the PF input processing section 185 may determine whether to set the vehicle speed and the number of revolutions to “zero” or not according to a signal from the storage section 14 or from a non-illustrated communication I/F.

By doing this, the input and output of data that should be made invalid depending on the specifications of the control device or the destination can be invalidated in the intermediate processing layer 108. Further, by updating the contents of the definition table 19, conformance to various specifications or destinations is achieved without any change in the operations of the AP I/F 181, the AP input processing section 182 and output processing section 183 and the PF input processing section 184 and output processing section 185, so that reusability of program parts can be improved and further, development efficiency can be improved.

Moreover, when a driving request is made, the door lock AP 161, the interior lamp AP 162, the headlamp control AP 163 and the self-diagnostic AP 164 all create data based on the data that is information-acquired from the platform layer 107 through the intermediate processing layer 108, and outputs the created data to the platform layer 107 through the intermediate processing layer 108. That is, although they are applications for different functions, the processing of creating input and output data is common thereto.

Therefore, in the present embodiment, further, the creation processing is substitutively executed as a function of the intermediate processing layer 108. Since the definition table 19 includes the definition information of the input and output data for each application, the CPU 11 is capable of substitutively executing the processing of combining pieces of data into one group according to with which application the input and output are exchanged or to which hardware resource the called PF I/F 171 conforms in the intermediate processing layer 108.

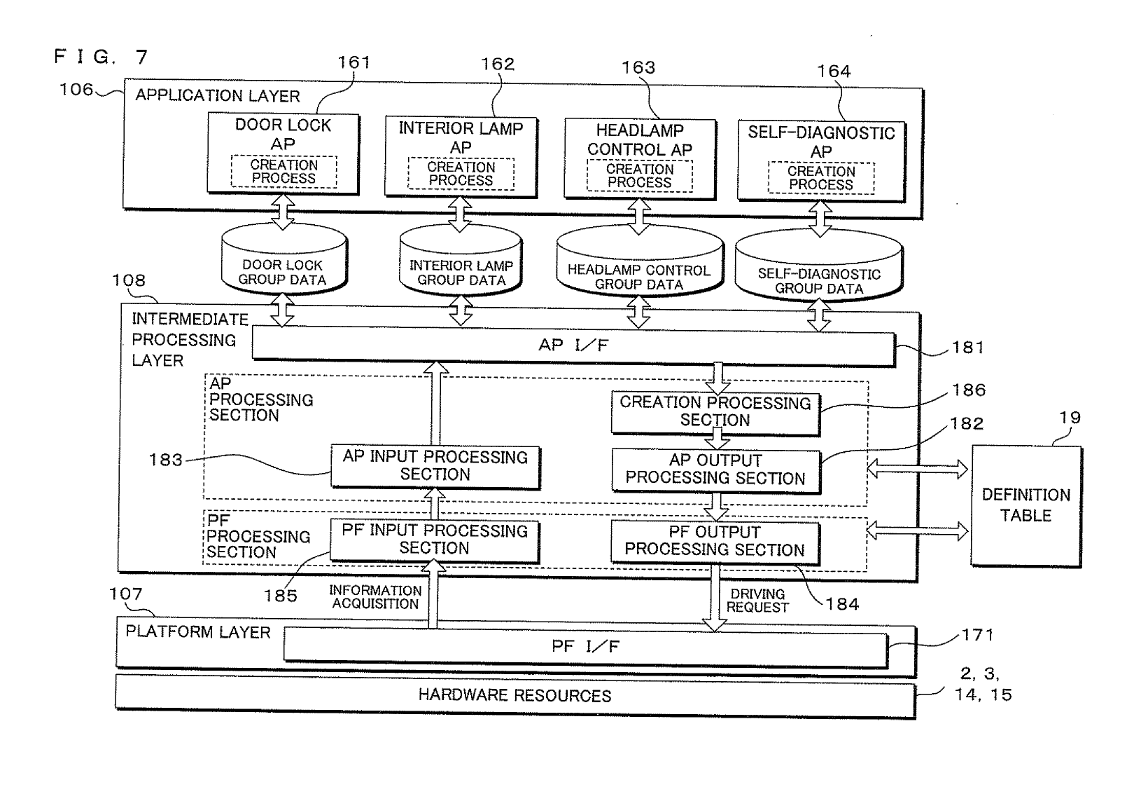

FIG. 7 is an explanatory view conceptually showing a structure in which the input and output data creation processing in each application program is substitutively executed in the intermediate processing layer 108. As shown in FIG. 7, the CPU 11 operates as a creation processing section 186 in the intermediate processing layer 108. The creation processing section 186 substitutively performs the data creation processing for when a driving request is made which processing is commonly executed by the door lock AP 161, the interior lamp AP 162, the headlamp control AP 163 and the self-diagnostic AP 164.

Specifically, the definition table 19 further includes the definition of data used as the reference for data when a driving request is made, for each of the door lock AP 161, the interior lamp AP 162, the headlamp control AP 163 and the self-diagnostic AP 164. The creation processing section 186 refers to the definition table 19 according to from which application the driving request is received. For example, for a driving request from the door lock AP 161, the creation processing section 186 creates data to be outputted, from data already acquired from the platform layer 107, and transmits it to the AP output processing section 182. The creation processing section 186 may be included in the AP output processing section 182.

By doing this, the common creation processing part in the door lock AP 161, the interior lamp AP 162, the headlamp control AP 163 and the self-diagnostic AP 164 can be removed from these application programs 16. Consequently, the scale of the application programs can be reduced, so that the processing speed can be increased.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-8. (canceled)

9. A control device including: a first program execution section for executing one or more application program; a second program execution section for executing a platform program to control an operation of one or more hardware resource in accordance with data from the application program or to transmit data of the hardware resource to the application program; and an intermediate processing execution section for executing input and output processing while conforming data to each other between the first program execution section and the second program execution section, the control device comprising
a table in which input and output data is defined while being associated with a plurality of different application programs and platform programs,
wherein
the intermediate processing execution section comprises:
a first processing section for converting input and output data based on the table, and executing the data input and output processing with the first program execution section; and
a second processing section for converting input and output data based on the table, and executing the data input and output processing with the second program execution section.

10. The control device according to claim 9, further comprising
a rewriting acceptance section for accepting rewriting of the table.

11. The control device according to claim 9, wherein
the table includes a first table which defines the number of pieces, type or format of input and output data for each of the different application programs; and
the first processing section
refers to the first table for the application program being executed by the first program execution section,
takes out data outputted from the first program execution section, based on the first table,
converts the data based on the first table, and
inputs the converted data to the first program execution section.

12. The control device according to claim 9, wherein
the table includes a second table which defines the number of pieces, type or format of input and output data for each platform program that differs depending on the hardware resource to be controlled, or a combination thereof: and
the second processing section
refers to the second table for the platform program being executed by the second program execution section, and
converts the data based on the second table at the time of data input and output with the second program execution section.

13. The control device according to claim 9, wherein
the input and output data is classified according to the data kind;
in the table, the input and output data is grouped according to the classification; and
the first processing section inputs the input and output data to the first program execution section group by group.

14. The control device according to claim 9, wherein
the hardware resource contains a memory, a sensor or an actuator.

15. The control device according to claim 9, wherein
the control device is a vehicular device.

16. The control device according to claim 11, further comprising
a setting acceptance section for accepting valid/invalid setting for each input and output data in the first table,
wherein
the first processing section converts, of the input and output data for the application program being executed, data that is set as invalid to a predetermined invalid value, and inputs and outputs the invalid value after the conversion.

17. The control device according to claim 11, wherein
in the input and output data in the first table, whether the data is valid or invalid is defined for each specification of the control device or for each destination.

18. The control device according to claim 11, wherein
the first program execution section outputs driving request data that contains information that the object of driving is the N-th object to the intermediate processing execution section;
the intermediate processing execution section accepts the driving request data, and supplies the data to the first processing section together with the specified information that the object is the N-th object;
the first processing section identifies the application program that outputted the driving request data, and identifies, from the first table, the definition information of the N-th input and output data associated with the identified application program, and notifies the second processing section of the driving request data based on the definition information; and
the second processing section calls the second program execution section in order to transmit the notified data, in a form based on the definition information.

19. The control device according to claims 11, wherein
the first program execution section outputs an information acquisition request to the intermediate processing execution section with a specification of the N-th data;
the intermediate processing execution section accepts the information acquisition request, and supplies the request to the first processing section;
the first processing section identifies the application program that outputted the information acquisition request, and identifies, from the first table, the definition information of the N-th data associated with the identified application program, and notifies the second processing section of acquisition of the N-th data;
the second processing section calls the second program execution section in order to acquire input data including the N-th data, in a form based on the definition information, and transmits, of the acquired input data, only the N-th data to the first processing section; and
the first processing section returns the N-th data to the first program execution section.

20. The control device according to claim 13, wherein
the group is grouped for each specification of the control device or for each destination.

21. A control method in which a processor of a computer executes one or more application program, executes a platform program to control an operation of a hardware resource in response to a request from the application program, and further, executes an intermediate processing program to perform input and output processing while converting input and output data between the application program and the platform program so as to conform to each other, thereby controlling the hardware resources, the method comprising the steps of:
the computer storing, in a memory, a table that is externally settable and in which input and output data is defined while being associated with application programs and platform programs; and
the processor
converting the input and output data so as to conform to the application program based on the table by the intermediate processing program, and
converting the input and output data so as to conform to the platform program based on the table by the intermediate processing program.

22. A control method in which a processor of a computer executes one or more application program, executes a platform program to control an operation of a hardware resource in response to a request from the application program, and further, executes an intermediate processing program to perform input and output processing while converting input and output data between the application program and the platform program so as to conform to each other, thereby controlling the hardware resource, the method comprising the steps of:
the computer storing, in a memory, a table that is externally settable and in which input and output data is defined while being associated with application programs and platform programs; and
the processor functioning as a first processing section for converting the input and output data so as to conform to the application program and as a second processing section for converting the input and output data so as to conform to the platform program, based on the table by the intermediate processing program;
the processor outputting driving request data that contains information that the object is the N-th object to the intermediate processing program by the application program;
the processor accepting the driving request data, and supplying the data to the first processing section together with the information that the object is the N-th object, by the intermediate processing program;
the first processing section identifying the application program that outputted the driving request data, identifying, from the table, the definition information of the N-th input and output data associated with the identified application program, and notifying the second processing section of the driving request data based on the definition information; and
the second processing section calling the platform program in order to transmit the notified driving request data, in a form based on the definition information.

23. The control method according to claim 22, wherein
the processor outputs an information acquisition request to the intermediate processing program with a specification of the N-th data;
the processor accepts the information acquisition request and supplies the request to the first processing section by the intermediate processing program;
the first processing section identifies the application program that outputted the information acquisition request, and identifies, from the table, the definition information of the N-th data associated with the identified application program, and notifies the second processing portion of acquisition of the N-th data;
the second processing section calls the platform program in order to acquire input data including the N-th data, in a form based on the definition information, and transmits, of the acquired input data, only the N-th data to the first processing section; and
the first processing section returns the N-th data to the first program execution section.

24. A non-transitory computer readable medium storing a computer program to cause a computer to execute data input and output between one or more application program and a platform program to control an operation of a hardware resource in response to a request from the application program, in accordance with each program, the computer program comprise the steps of
causing the computer to convert input and output data so as to conform to the application program based on a table in which input and output data is defined while being associated with different application programs, and
causing the computer to convert the input and output data so as to conform to the platform program based on a table in which input and output data is defined while being associated with different platform programs.

25. A non-transitory computer readable medium storing a computer program to cause a computer to execute data input and output between one or more application program and a platform program to control an operation of a hardware resource in response to a request from the application program, in accordance with each program, the computer program comprise the steps of
causing the computer to function as a first processing section for converting the input and output data so as to conform to the application program based on first table in which input and output data is defined while being associated with different application programs, and
causing the computer to function as a second processing section for converting the input and output data so as to conform to platform program based on second table in which input and output data is defined while being associated with different platform programs,
the first processing section accepting driving request data that contains information that the object of driving is the N-th object, identifying the application program that outputted the driving request data, identifying, from the first table, the definition information of the N-th input and output data associated with the identified application program, and notifying the second processing section of the driving request data based on the definition information; and
the second processing section calling platform program in order to transmit the notified driving request data, in a form based on the second table.

26. A non-transitory computer readable medium storing a computer program to cause a computer to execute data input and output between one or more application program and a platform program to control an operation of a hardware resource in response to a request from the application program, in accordance with each program, the computer program comprise the steps of
causing the computer to function as a first processing section for converting the input and output data so as to conform to the application program based on first table in which input and output data is defined while being associated with different application programs, and
causing the computer to function as a second processing section for converting the input and output data so as to conform to platform program based on second table in which input and output data is defined while being associated with different platform programs,
the first processing section accepting an information acquisition request with a specification of the N-th data, identifying the application program that outputted the information acquisition request, identifying, from the first table, the definition information of the N-th input and output data associated with the identified application program, and notifying the second processing section of the driving request data based on the definition information;
the second processing section calling platform program in order to transmit the notified in order to acquire input data including the N-th data, in a form based on the definition information, and transmitting, of the acquired input data, only the N-th data to the first processing section; and
the first processing section returning the N-th data to the application program.
